(19) United States
(12) Patent Application Publication
(10) Pub. No.: US 2014/0155057 A1
(43) Pub. Date: Jun. 5, 2014

(54) METHOD AND APPARATUS FOR ASSOCIATING REPORTS

(71) Applicant: Huawei Technologies Co., Ltd., Shenzhen (CN)

(72) Inventors: Haitao XIA, Beijing (CN); Lan ZOU, Shanghai (CN); Dong ZHAO, Shanghai (CN)

(73) Assignee: Huawei Technologies Co., Ltd., Shenzhen (CN)

(21) Appl. No.: 14/175,051

(22) Filed: Feb. 7, 2014

Related U.S. Application Data
(63) Continuation of application No. PCT/CN2012/076742, filed on Jun. 12, 2012.

(30) Foreign Application Priority Data
Aug. 10, 2011 (CN) 201110228841.4
Sep. 29, 2011 (CN) 201110295649.7

(51) Int. Cl. H04W 24/10; H04W 88/08; H04W 24/08

(52) U.S. Cl. CPC H04W 24/10; H04W 24/08; H04W 88/08
USPC 455/423

(57) ABSTRACT

The present disclosure provides a method and an apparatus for associating reports, and relates to the field of radio communications, which are used to solve the problem in the prior art that an analysis and location result is not precise enough because information of an RLF report and an MDT measurement report of a UE cannot be fully applied in analysis and location of a radio link problem on a network. The method for associating reports includes: sending, by a base station, to a UE that executes an MDT job an identifier allocated to the UE; receiving, by the base station, an RLF report of the UE, where the RLF report includes the identifier; and associating, by the base station, the RLF report of the UE with an MDT measurement report that includes the identifier.

### CROSS-REFERENCE TO RELATED APPLICATIONS

This application is a continuation of International Patent Application No. PCT/CN2012/076742, filed on Jun. 12, 2012, which claims priority to Chinese Patent Application No. 201110228841.4, filed on Aug. 10, 2011 and Chinese Patent Application No. 201110295649.7, filed on Sep. 29, 2011. The afore-mentioned patent applications are hereby incorporated by reference in their entireties.

### TECHNICAL FIELD

The present disclosure relates to the field of radio communications, and in particular, to a method and an apparatus for associating reports.

### BACKGROUND

A radio link failure (RLF) is a link abnormality phenomenon occurring in an air interface of a radio access network. When an RLF occurs on a user equipment (UE) in an active state, the UE automatically records related information of time at which the RLF occurs to form an RLF report, and reports the RLF report to a network side base station.

A minimized drive test (MDT) is a new UE measurement and report function used to reduce conventional drive tests performed by an operator at phases of network establishment and subsequent maintenance and to improve the drive test working efficiency. The UE in a connected state or in an idle state can record network measurement details and recording the time and position of the record, to form an MDT measurement report.

In the prior art, a process of analyzing and locating a radio link problem on a network uses only the MDT measurement report and cannot use the RLF report. Therefore, information of the MDT measurement report and the RLF report cannot be fully applied in the process of problem analysis and location, which makes a result of problem analysis and location not precise enough.

### SUMMARY

The present disclosure provides methods and apparatus for associating reports, which can solve the problem in the prior art that an analysis and location result is not precise enough because information of an RLF report and an MDT measurement report of a UE cannot be fully applied in analysis and location of a radio link problem on a network.

In one aspect, the present disclosure provides a method for associating reports, including:

sending, by a base station, to a UE that executes an MDT job an identifier allocated to the UE;

receiving, by the base station, an RLF report of the UE, where the RLF report includes the identifier; and

associating, by the base station, the RLF report of the UE with an MDT measurement report that includes the identifier.

In another aspect, the present disclosure provides a method for associating reports, including:

receiving, by a base station, an RLF report of a UE that executes an MDT job, where the RLF report includes an identifier allocated by a source base station of the UE to the UE; and

sending, by the base station, the RLF report of the UE, so that a receiver of the RLF report of the UE associates the RLF report of the UE with an MDT measurement report that includes the identifier.

In another aspect, the present disclosure provides a method for associating reports, including:

receiving, by a base station, an RLF report of a UE that executes an MDT job; and

sending, by the base station, the RLF report of the UE to an operation, administration and maintenance OAM system, so that the OAM system associates the RLF report of the UE with an MDT measurement report that includes an identifier of the UE;

where the RLF report received by the base station does not carry the identifier of the UE, the RLF report sent by the base station includes the identifier of the UE, and the identifier of the UE is an identifier allocated by a source base station of the UE to the UE.

In another aspect, the present disclosure provides a method for associating reports, including:

receiving, by an OAM system, an RLF report and an MDT measurement report that are sent by a base station; and

if both the RLF report and the MDT measurement report carry an identifier allocated by a source base station of a UE to the UE, associating, by the OAM system, the RLF report with the MDT measurement report.

In another aspect, the present disclosure provides a method for associating reports, including:

receiving, by a UE that executes an MDT job, an identifier allocated by a source base station of the UE to the UE; and

when a radio link failure RLF occurs on the UE, sending, by the UE, an RLF report to a base station, where the RLF report includes the identifier allocated by the source base station to the UE, so that the RLF report of the UE is associated with an MDT measurement report that includes the identifier.

In another aspect, the present disclosure provides a base station, including:

a first sending unit, configured to send to a UE that executes an MDT job an identifier allocated to the UE;

a first receiving unit, configured to receive an RLF report of the UE, where the RLF report includes the identifier; and

a first processing unit, configured to associate the RLF report of the UE with an MDT measurement report that includes the identifier.

In another aspect, the present disclosure provides a base station, including:

a second receiving unit, configured to receive an RLF report of a UE that executes an MDT job, where the RLF report includes an identifier allocated by a source base station of the UE to the UE; and

a second sending unit, configured to send the RLF report of the UE, so that a receiver of the RLF report of the UE associates the RLF report of the UE with an MDT measurement report that includes the identifier.

In another aspect, the present disclosure provides a base station, including:

a third receiving unit, configured to receive an RLF report of a UE that executes an MDT job; and

a third sending unit, configured to send the RLF report of the UE to an operation, administration and maintenance OAM system, so that the OAM system associates the RLF report of the UE with an MDT measurement report that includes an identifier of the UE;

where the RLF report received by the third receiving unit does not carry the identifier of the UE, the RLF report sent by the third sending unit includes the identifier of the UE, and the identifier of the UE is an identifier allocated by a source base station of the UE to the UE.

In another aspect, the present disclosure provides an OAM system, including:

a fourth receiving unit, configured to receive an RLF report and an MDT measurement report that are sent by a base station; and

a fourth processing unit, configured to: if both the RLF report and the MDT measurement report carry an identifier allocated by a source base station of a UE to the UE, associate the RLF report with the MDT measurement report.

In another aspect, the present disclosure provides a UE that executes an MDT job, including:

a fifth receiving unit, configured to receive an identifier allocated by a source base station of the UE to the UE; and

a fifth sending unit, configured to: when the UE executes the MDT job and an RLF occurs on the UE, send an RLF report to a base station, where the RLF report includes the identifier allocated by the source base station to the UE, so that the RLF report of the UE is associated with an MDT measurement report that includes the identifier.

In the foregoing technical solutions, an RLF report and an MDT measurement report that include a same identifier are associated, so that complementary information included in an RLF report and an MDT measurement report reported by a same UE is associated and applied in analysis and location of a radio link problem on a network, thereby making a result of analysis and location more precise.

### BRIEF DESCRIPTION OF DRAWINGS

To illustrate the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a flowchart of a method according to an embodiment of the present disclosure;

FIG. 2 is a flowchart of a method according to another embodiment of the present disclosure;

FIG. 3 is a flowchart of a method according to another embodiment of the present disclosure;

FIG. 4 is schematic structural diagram of a base station according to another embodiment of the present disclosure;

FIG. 5 is schematic structural diagram of a base station according to another embodiment of the present disclosure;

FIG. 6 is schematic structural diagram of a base station according to another embodiment of the present disclosure;

FIG. 7 is schematic structural diagram of a base station according to another embodiment of the present disclosure;

FIG. 8 is schematic structural diagram of an OAM system according to another embodiment of the present disclosure;

FIG. 9 is schematic structural diagram of a UE according to another embodiment of the present disclosure; and

FIG. 10 is a flowchart of a method for obtaining information according to another embodiment of the present disclosure.

### DESCRIPTION OF EMBODIMENTS

The following clearly describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

In all embodiments of the present disclosure, a base station serving a cell where an RLF occurs on a UE is a source base station, and a base station serving a cell where the UE re-establishes a radio resource control (RRC) connection successfully after the occurrence of the RLF is a target base station. It should be noted that the target base station may be a base station different from the source base station and may also be a base station the same as the source base station. For example, if a base station serving a cell where the UE re-establishes an RRC connection successfully after the occurrence of the RLF is still a base station serving a cell where no RLF occurs on the UE, the target base station and the source base station are the same base station.

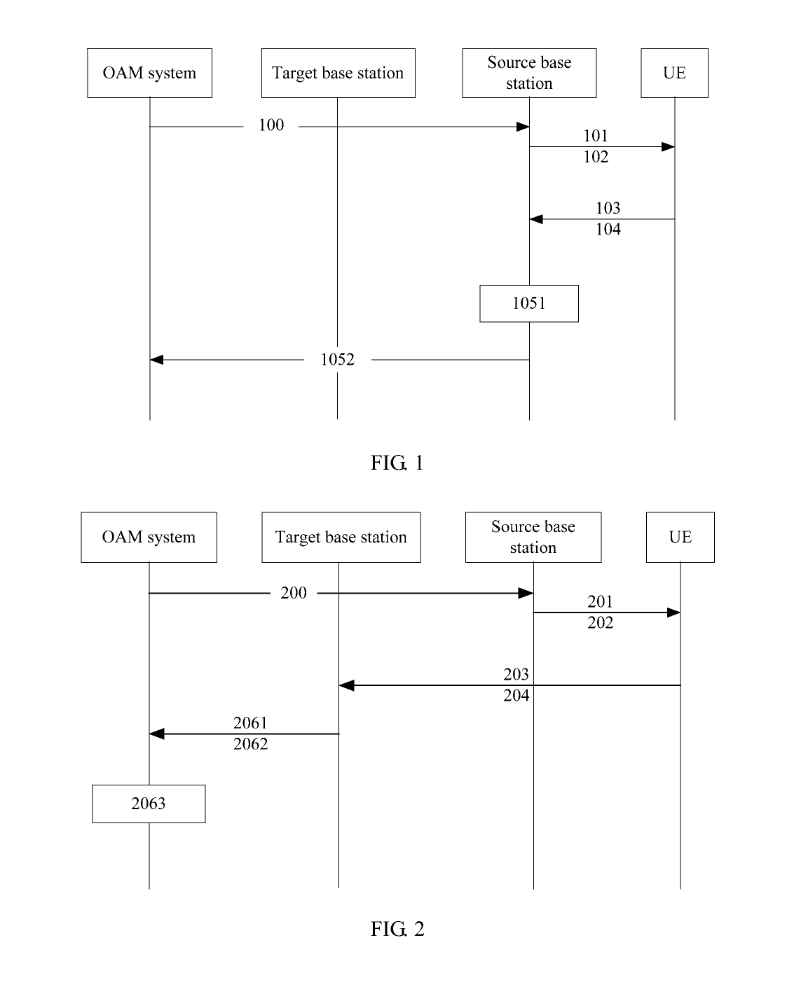

As shown in FIG. 1, an embodiment of the present disclosure provides a method for associating reports, including the following steps:

Step 101: A source base station sends to a UE that executes an MDT job an identifier allocated to the UE.

Optionally, in all the embodiments of the present disclosure, the identifier allocated by the source base station to the UE that executes the MDT job may be a combination of a trace reference (TR) and a trace recording session reference (TRSR) or a combination of a TR, a TRSR and a cell identifier. The combination of the TR and the TRSR herein refers to an identifier set formed by the TR and the TRSR. Because the TR is a job identifier allocated by an operation, administration and maintenance (OAM) system to a base station when the OAM system creates an MDT job, the TR can identify one MDT job on a whole public land mobile network (PLMN). The TRSR is an identifier allocated by the base station, which selects a UE to execute an MDT job, to the UE and used to record MDT measurement information when the base station. Therefore, the combination of the TR and the TRSR corresponds to a UE that executes an MDT job and performs MDT measurement and recording. It may be understood that there exists a uniquely determined relationship between the combination of the TR and the TRSR and the UE. It should be noted that when the UE that executes an MDT job performs a handover process within a PLMN, the combination of the TR and the TRSR corresponding to the UE may remain unchanged. In particular, in an MDT job based on a management area, because the OAM system selects base stations of multiple cells within the area to participate in the MDT job, the base stations of different cells may allocate a same TRSR to different UEs. Therefore, to further differentiate different UEs (that execute the MDT) with the same TRSR, a combination of the TR, the TRSR, and the cell identifier may be used as an identifier corresponding to a UE that executes an MDT job.

Optionally, a specific process of sending an identifier to a UE that executes an MDT job by a source base station is: sending, by the source base station, an RRC connection reconfiguration message to the UE that executes the MDT job, where the message includes the identifier allocated by the source base station to the UE.

It may be understood that the MDT job in this embodiment is an immediate MDT job. Optionally, this embodiment further includes step 100 before step 101. In step 100, the source base station receives a job type sent by an OAM system; when a value of the job type is immediate MDT and RLF reporting, the source base station sends to the UE the identifier allocated to the UE. For example, the source base station receives a signaling trace session activation request command sent by the OAM system, where the command includes a job type, which means that the job type is a parameter carried in the command. The source base station determines, according to the value of the Job Type, whether to send to the UE the identifier allocated to the UE. After step 100, the source base station may execute step 101, that is, send the identifier allocated to the UE.

Step 102: The UE that executes the MDT job receives the identifier allocated by the source base station of the UE to the UE.

Step 103: When an RLF occurs on the UE, the UE sends an RLF report to the source base station, where the RLF report includes the identifier allocated by the source base station to the UE.

Specifically, this step may be as follows: The UE may write the received identifier allocated by the source base station of the MDT job to the UE in step 101 to the RLF report, so that the RLF report includes the identifier allocated by the source base station to the UE. Optionally, if a target base station and the source base station of the UE are the same base station, in this step, the UE sends the RLF report to the source base station directly, which means that the RLF report may not be forwarded through other devices. Alternatively, if the target base station and the source base station of the UE are different base stations, in this step, the UE firstly sends the RLF report to the target base station, and then the target base station sends the RLF report to the source base station.

Step 104: The source base station receives the RLF report of the UE, where the RLF report includes the identifier of the UE.

Optionally, in this embodiment, the source base station or the OAM system may associate the RLF report and an MDT measurement report. The following describes these two cases.

Case 1: The source base station completes the association process. Referring to FIG. 1, the process includes the following step 1051.

Step 1051: The source base station associates the RLF report of the UE with an MDT measurement report that includes the identifier.

Optionally, this step specifically includes: combining, by the base station, the RLF report of the UE with the MDT measurement report that includes the same identifier. For example, the base station reserves one copy of identical records in the RLF report and the MDT measurement report with the same identifier, and reserves different records in the RLF report and the MDT measurement report concurrently. That is, a combination result includes all information of the RLF report and the MDT measurement report of the same UE, and includes no repeated information. Optionally, the combination result is still a report, that is, the association result of the source base station is a report after combination.

Optionally, in Case 1, after step 1051, the source base station further reports an association result between the RLF report of the UE and the MDT measurement report that includes the identifier to the OAM system (that is, step 1052).

Case 2: The OAM system completes the association process. This process is not shown in FIG. 1, and includes the following steps 1061 to 1063.

Step 1061: The source base station sends the received RLF report of the UE to the OAM system.

Step 1062: The OAM system receives the RLF report sent by the source base station.

Step 1063: If both the RLF report and an MDT measurement report received by the OAM system carry an identifier allocated by a source base station of a UE to the UE, the OAM system associates the RLF report with the MDT measurement report.

Optionally, in Case 2, the MDT measurement report received by the OAM system is sent by the source base station according to a current process.

Solutions in all the embodiments of the present disclosure are applicable to a scenario where the source base station and the target base station belong to a same PLMN network, and are applicable to a scenario where the source base station and the target base station belong to different PLMN networks of a same operator, and are also applicable to a scenario where the source base station or the target base station is a base station shared by PLMN networks of multiple operators.

The scenario where a base station is shared by PLMN networks of multiple operators refers to that a same base station belongs to different operators, that is, a scenario where PLMN networks of at least two operators share a same physical base station. Different operators use different network management systems (NMS) to manage the shared base station. It should be noted that the NMS is one implementation form in the OAM system.

If the source base station or the target base station of the UE is a base station shared by multiple PLMNs, in this embodiment, the RLF report sent by the UE to the source base station in step 103 may further carry at least one of information of a registered PLMN (RPLMN) of the UE and information of a home PLMN (HPLMN) of the UE. In this way, the source base station can obtain, through the process of receiving the RLF report of the UE in step 104, the information of the registered PLMN of the UE and/or the information of the home PLMN of the UE. The RPLMN information is used to indicate that the RLF report is reported to an NMS of a target PLMN specified by the RPLMN information; the HPLMN information is used to indicate that the RLF report is reported to an NMS of a target PLMN network specified by the information of the HPLMN. The UE can determine, according to a network sharing protocol agreement between operators, whether to write the RPLMN information or the HPLMN information to the RLF report.

In the method for associating report provided by the embodiment of the present disclosure, the UE receives an identifier allocated by the source base station to the UE, and writes the identifier to an RLF report when an RLF occurs on the UE, so that the source base station or the OAM system associates the RLF report of the UE with an MDT measurement report that includes the identifier. In this way, complementary information included in the RLF report and the MDT measurement report of the same UE can be applied in analysis and location of a radio link problem on a network, thereby making a result of analysis and location more precise. Further, the source base station can determine, according to a fact that the OAM system sets a job type of a signaling trace job to immediate MDT and RLF reporting, that the identifier allocated to the UE needs to be sent to the UE, to support the signaling trace job customized by the OAM system according to management application requirements.

A method for associating reports provided by another embodiment of the present disclosure includes the following steps:

Step 201: A source base station sends to a UE that executes an MDT job an identifier allocated to the UE.

For details about an example of this step, reference may be made to step 101 in the forgoing embodiment.

Optionally, this embodiment further includes step 200 before step 201. In step 200, the source base station receives a job type sent by an OAM system. When a value of the job type is immediate MDT and RLF reporting, the source base station sends to the UE the identifier allocated to the UE. For details about an example of step 200, reference may be made to step 100 in the forgoing embodiment.

Step 202: The UE that executes the MDT job receives the identifier allocated by the source base station of the UE to the UE.

For details about an example of this step, reference may be made to step 102 in the forgoing embodiment.

Step 203: When an RLF occurs on the UE, the UE sends an RLF report to a target base station, where the RLF report includes the identifier allocated by the source base station to the UE.

Step 204: The target base station receives the RLF report of the UE that executes the MDT job, that is, the RLF report sent by the UE in step 203.

Further, in this embodiment, the target base station may send the RLF report of the UE, so that a receiver that receives the RLF report of the UE from the target base station can associate the RLF report of the UE with an MDT measurement report that includes the identifier. Optionally, the receiver may be the source base station of the UE or the OAM system. The following exemplifies specific solutions.

Solution 1: The receiver is the source base station of the UE, which is not shown in FIG. 2.

Step 2051: The target base station of the UE sends the RLF report of the UE to the source base station of the UE.

Step 2052: The source base station of the UE receives the RLF report of the UE, and associates the RLF report of the UE with an MDT measurement report that includes the identifier.

Further, this solution may further include the following step:

Step 2053: The source base station reports an association result in step 2052 to the OAM system.

Solution 2: The receiver is the OAM system, referring to FIG. 2.

Step 2061: The target base station of the UE sends the RLF report of the UE to the OAM system.

Step 2062: The OAM system receives the RLF report sent by the target base station.

Step 2063: If both the RLF report and an MDT measurement report received by the OAM system carry the identifier allocated by the source base station of the UE to the UE, the OAM system associates the RLF report with the MDT measurement report. The MDT measurement report received by the OAM system may be sent by the source base station to the OAM system according to a current process.

In this embodiment, if the source base station or the target base station of the UE is a base station shared by multiple PLMNs, the RLF report sent by the UE to the target base station in step 203 may further carry information of a registered PLMN of the UE and/or information of a home PLMN of the UE. In this way, the target base station can obtain, through the process of receiving the RLF report of the UE in step 204, the information of the registered PLMN of the UE and/or the information of the home PLMN of the UE.

In the method for associating report provided by the embodiment of the present disclosure, the UE receives an identifier allocated by the source base station to the UE, writes the identifier to an RLF report when an RLF occurs on the UE, and sends the RLF report that includes the identifier to the target base station; and the target base station sends the RLF report that includes the identifier to the source base station or the OAM system, so that the source base station or the OAM system associates the RLF report of the UE with an MDT measurement report that includes the identifier. In this way, complementary information included in the RLF report and the MDT measurement report of the same UE can be applied in analysis and location of a radio link problem on a network, thereby making a result of analysis and location more precise. Further, the source base station can determine, according to a fact that the OAM system sets a job type of a signaling trace job to immediate MDT and RLF reporting, that the identifier allocated to the UE needs to be sent to the UE, to support the signaling trace job customized by the OAM system according to management application requirements.

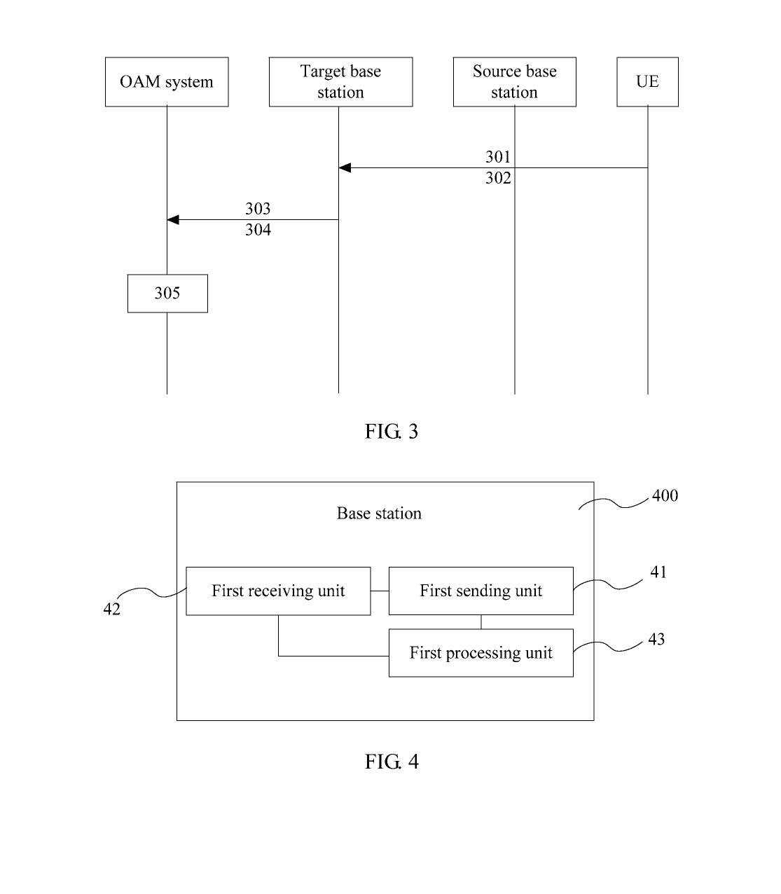

As shown in FIG. 3, a method for associating reports provided by another embodiment of the present disclosure includes the following steps:

Step 301: When an RLF occurs on a UE that executes an MDT job, the UE sends an RLF report to a target base station.

The RLF report does not carry an identifier of the UE and may be sent by the UE according to a current process.

Step 302: The target base station receives the RLF report of the UE that executes the MDT job.

The RLF report in this step is the RLF report that is sent by the UE in step 301 and does not carry the identifier of the UE.

Step 303: The target base station sends the received RLF report to an OAM system, and includes the identifier of the UE in the RLF report.

The identifier of the UE is obtained by the target base station by parsing local MDT context information and is added to the RLF report received in step 302. The local MDT context information is obtained by parsing received UE context information and stored by the target base station.

Step 304: The OAM system receives the RLF report sent by the target base station.

Step 305: If both the RLF report and an MDT measurement report received by the OAM system carry an identifier allocated by a source base station of a UE to the UE, the OAM system associates the RLF report with the MDT measurement report.

The MDT measurement report received by the OAM system may be sent by the source base station to the OAM system according to a current process.

If the base station is a base station shared by multiple PLMNs, the RLF report received by the target base station may further carry information of a registered PLMN of the UE and/or information of a home PLMN of the UE.

In the method for associating report provided by the embodiment of the present disclosure, the target base station receives an RLF report that does not carry an identifier of the UE, writes the identifier to the RLF report, and sends the RLF report that includes the identifier to the OAM system, so that the OAM system associates the RLF report of the UE with an MDT measurement report that includes the identifier. In this way, complementary information included in the RLF report and the MDT measurement report of the same UE can be applied in analysis and location of a radio link problem on a network, thereby making a result of analysis and location more precise.

An embodiment of the present disclosure further provides an apparatus for associating reports, which is exemplified as follows:

As shown in FIG. 4, an embodiment of the present disclosure provides a base station 400, including a first sending unit 41, a first receiving unit 42, and a first processing unit 43. The first sending unit 41 is configured to send to a UE that executes an MDT job an identifier allocated to the UE. Optionally, the identifier may be a combination of a TR and a TRSR or a combination of a TR, a TRSR and a cell identifier. The first receiving unit 42 is configured to receive an RLF report of the UE, where the RLF report includes the identifier. The first processing unit 43 is configured to associate the RLF report of the UE with an MDT measurement report that includes the identifier.

Optionally, the first sending unit 41 is specifically configured to send an RRC connection reconfiguration message to the UE that executes the MDT job, where the message includes the identifier allocated by the base station 400 to the UE.

Optionally, the first processing unit 43 is specifically configured to combine the RLF report of the UE with the MDT measurement report that includes the same identifier.

The first sending unit 41 in the base station 400 may be further configured to report an association result between the RLF report of the UE and the MDT measurement report that includes the identifier to an OAM system.

In addition, if the base station 400 is a base station shared by multiple PLMNs, the RLF report of the UE received by the first receiving unit 41 may further carry at least one of information of a registered PLMN of the UE and information of a home PLMN of the UE.

Optionally, the first receiving unit 42 is further configured to receive a job type sent by the OAM system, for example, the first receiving unit 42 is specifically configured to receive a trace session activation request command sent by the OAM system, where the command includes a job type. The first sending unit 41 is further configured to: when a value of the job type received by the first receiving unit 42 is immediate MDT and RLF reporting, send to the UE the identifier allocated to the UE.

The base station 400 provided by the embodiment of the present disclosure may be a source base station of a UE, in which the first receiving unit receives an RLF report that includes an identifier, and the first processing unit associates the RLF report that includes the identifier with an MDT measurement report that includes the identifier. In this way, complementary information included in the RLF report and the MDT measurement report of the same UE can be applied in analysis and location of a radio link problem on a network, thereby making a result of analysis and location more precise.

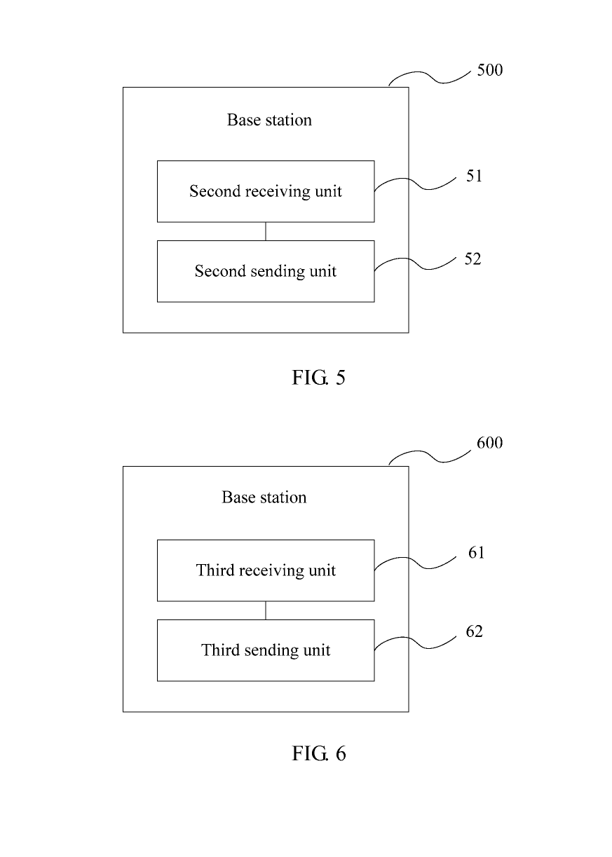

As shown in FIG. 5, another embodiment of the present disclosure provides a base station 500, including a second receiving unit 51 and a second sending unit 52. The second receiving unit 51 is configured to receive an RLF report of a UE that executes an MDT job, where the RLF report includes an identifier allocated by a source base station of the UE to the UE. Optionally, the identifier may be a combination of a TR and a TRSR or a combination of a TR, a TRSR and a cell identifier. The second sending unit 52 is configured to send the RLF report of the UE, so that a receiver of the RLF report of the UE associates the RLF report of the UE with an MDT measurement report that includes the identifier.

Optionally, the receiver of the RLF report may be the source base station of the UE or an OAM system. The second sending unit 52 is specifically configured to send the RLF report of the UE to the source base station of the UE, so that the source base station of the UE associates the RLF report of the UE with the MDT measurement report that includes the identifier; or, the second sending unit is specifically configured to send the RLF report of the UE to the OAM system, so that the OAM system associates the RLF report of the UE with the MDT measurement report that includes the identifier.

In addition, the RLF report of the UE received by the second receiving unit 51 may further carry information of a registered PLMN of the UE and/or information of a home PLMN of the UE. In this case, the base station 500 may be a base station shared by multiple PLMNs.

The base station 500 provided by the embodiment of the present disclosure may be a target base station of a UE, in which the second receiving unit receives an RLF report that includes an identifier, and the second sending unit sends the RLF report that includes the identifier to a source base station or an OAM system, so that the source base station or the OAM system can associate the RLF report that includes the identifier with an MDT measurement report that includes the identifier. In this way, complementary information included in the RLF report and the MDT measurement report of the same UE can be applied in analysis and location of a radio link problem on a network, thereby making a result of analysis and location more precise.

As shown in FIG. 6, another embodiment of the present disclosure provides a base station 600, including a third receiving unit 61 and a third sending unit 62. The third receiving unit 61 is configured to receive an RLF report of a UE that executes an MDT job. The third sending unit 62 is configured to send the RLF report of the UE to an OAM system, so that the OAM system associates the RLF report of the UE with an MDT measurement report that includes an identifier of the UE. The RLF report received by the third receiving unit 61 does not carry the identifier of the UE, the RLF report sent by the third sending unit 62 includes the identifier of the UE, and the identifier of the UE is an identifier allocated by a source base station of the UE to the UE.

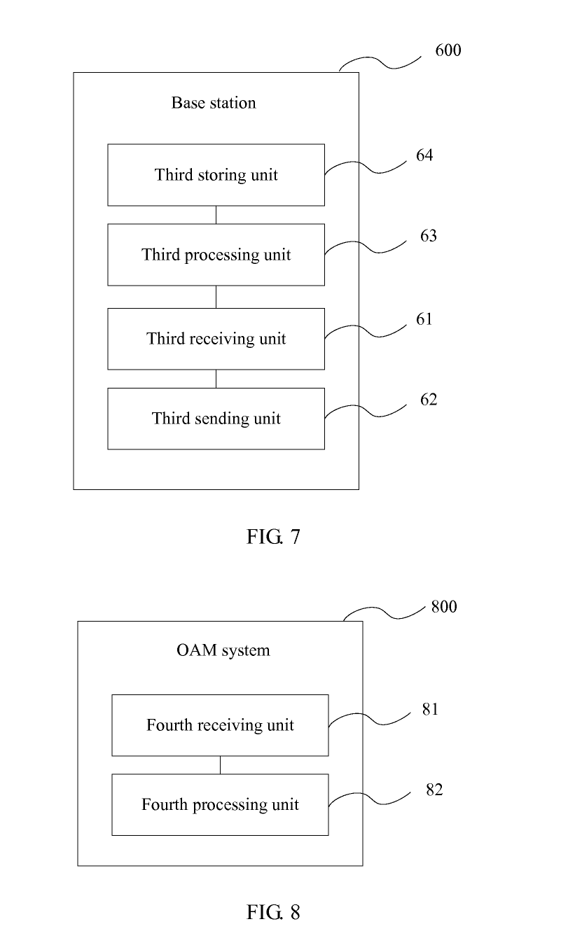

Optionally, the identifier may be a combination of a TR and a TRSR or a combination of a TR, a TRSR and a cell identifier. Optionally, as shown in FIG. 7, the base station 600 further includes a third processing unit 63, and may further include a third storing unit 64. The identifier of the UE is obtained by the third processing unit 63 of the base station 600 by parsing local MDT context information and is added to the received RLF report. Optionally, the local MDT context information is stored in the third storing unit 64 of the base station 600, for example, the third receiving unit 61 is further configured to receive UE context information that includes the MDT context information, so that the third storing unit 64 stores the UE context information.

In addition, the RLF report of the UE received by the third receiving unit may further carry information of a registered PLMN of the UE and/or information of a home PLMN of the UE. In this case, the base station 600 is a base station shared by multiple PLMNs.

The base station 600 provided by the embodiment of the present disclosure is a target base station of a UE, in which the third receiving unit receives an RLF report that does not carry an identifier, the third processing unit writes the identifier to the RLF report that does not carry the identifier, and the third sending unit sends the RLF report that includes the identifier to an OAM system, so that the OAM system can associate the RLF report that includes the identifier with an MDT measurement report that includes the identifier. In this way, complementary information included in the RLF report and the MDT measurement report of the same UE can be applied in analysis and location of a radio link problem on a network, thereby making a result of analysis and location more precise.

As shown in FIG. 8, another embodiment of the present disclosure provides an OAM system 800, including a fourth receiving unit 81 and a fourth processing unit 82. The fourth receiving unit 81 is configured to receive an RLF report and an MDT measurement report that are sent by a base station. The fourth processing unit 82 is configured to: if both the RLF report and the MDT measurement report carry an identifier allocated by a source base station of a UE to the UE, associate the RLF report with the MDT measurement report.

Optionally, the identifier may be a combination of a TR and a TRSR or a combination of a TR, a TRSR and a cell identifier.

Optionally, the fourth processing unit 82 is specifically configured to: if both the RLF report and the MDT measurement report carry the identifier allocated by the source base station of the UE to the UE, combine the RLF report with the MDT measurement report.

In the OAM system provided by the embodiment of the present disclosure, the fourth receiving unit receives an RLF report that includes an identifier, and the fourth processing unit associates the RLF report that includes the identifier with an MDT measurement report that includes the identifier. In this way, complementary information included in the RLF report and the MDT measurement report of the same UE can be applied in analysis and location of a radio link problem on a network, thereby making a result of analysis and location more precise.

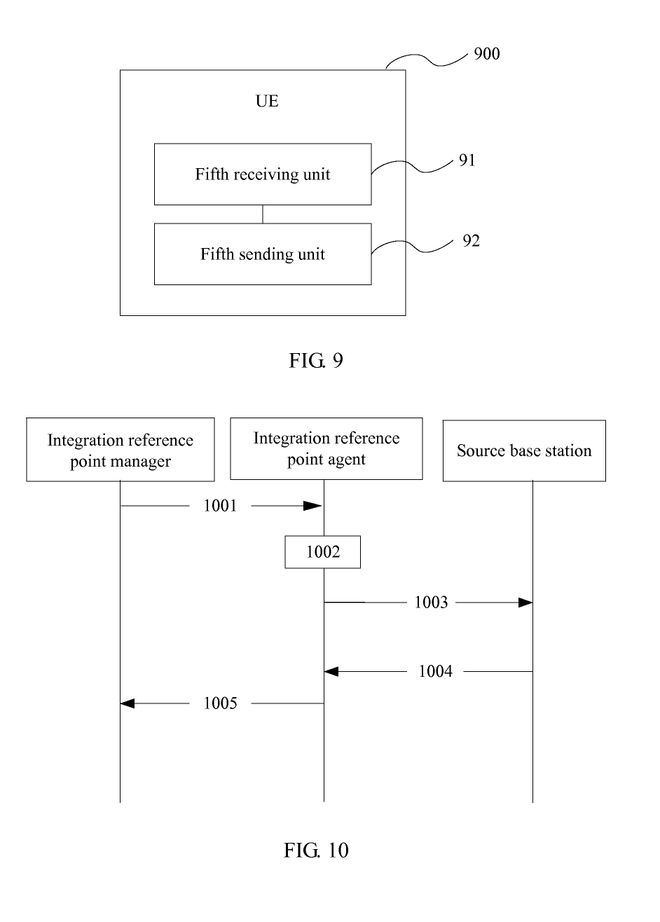

As shown in FIG. 9, a UE 900 is provided, including a fifth receiving unit 91 and a fifth sending unit 92. The fifth receiving unit 91 is configured to receive an identifier allocated by a source base station of the UE to the UE. The fifth sending unit 92 is configured to: when the UE executes an MDT job and an RLF occurs on the UE, send an RLF report to a base station, where the RLF report includes the identifier allocated by the source base station to the UE, so that the RLF report of the UE is associated with an MDT measurement report that includes the identifier.

The base station is the source base station of the UE or a target base station of the UE.

Optionally, the identifier may be a combination of a TR and a TRSR or a combination of a TR, a TRSR and a cell identifier.

If the base station is a base station shared by multiple PLMNs, the RLF report sent by the fifth sending unit 92 to the base station may further carry information of a registered PLMN of the UE and/or information of a home PLMN of the UE.

In the UE provided by the embodiment of the present disclosure, the fifth receiving unit receives an identifier allocated by a source base station of the UE to the UE, and when an RLF occurs on the UE, an RLF report that includes the identifier is sent to the source base station or a target base station, so that the RLF report that includes the identifier can be associated with an MDT measurement report that includes the identifier. In this way, complementary information included in the RLF report and the MDT measurement report of the same UE can be applied in analysis and location of a radio link problem on a network, thereby making a result of analysis and location more precise.

It should be noted that the base station, the OAM system and the UE in the foregoing embodiments can be configured to implement the methods provided in the foregoing embodiments. Therefore, for details about the base station, the OAM system and the UE, reference may be made to the foregoing method embodiments, and details are not further described herein.

In different management application scenarios, an operator may use different reports to provide information needed by management. For example, if the operator needs to draw a cell coverage map of a network, the operator may use an MDT measurement report, where the MDT measurement report includes information of cell signal sampling points needed to draw the cell coverage map. If the operator needs to optimize coverage of one cell within a network, the operator needs to associate an RLF report with an MDT measurement report to obtain more detailed sampling points and sampling events of cell signals at different positions, to help to locate coverage problems. However, in the prior art, information needed to optimize the cell coverage usually cannot be obtained timely.

Another embodiment of the present disclosure provides a method for obtaining information, where the method can solve the foregoing problem and includes the following steps. This embodiment may be shown in FIG. 10.

Step 1001: An integration reference point manager (IRPManager) invokes an activate signaling trace job (activateTraceJob) operation from an integration reference point agent (IRPAgent) to request the IRPAgent to generate a signaling trace job, where a job type of the signaling trace job is immediate MDT and RLF reporting.

For example, the IRPManager invokes an activate signaling trace job operation from a signaling trace job integration reference point (Trace IRP) to the IRPAgent, where the activate signaling trace job operation may be specifically an activate signaling trace job operation of the signaling trace job, where the signaling trace job is a managed object of the IRPManager.

Step 1002: The IRPAgent generates a signaling trace job, where a job type of the signaling trace job is immediate MDT and RLF reporting.

Step 1003: The IRPAgent sends a signaling trace session activation request command to a source base station, where the command includes a job type, which means that the job type is a parameter carried in the command. The source base station determines whether to send to a UE an identifier allocated to the UE according to whether the value of the job type is immediate MDT and RLF reporting.

Step 1004: The IRPAgent obtains an association result between an MDT measurement report and an RLF report and sent by the source base station, and sends the association result to a trace collection entity (TCE) in the IRPManager. The association result may be a combination result between the MDT measurement report and the RLF report, for example, a combination result between the RLF report of the UE and the MDT measurement report that includes the identifier of the same UE in the foregoing embodiment.

Step 1005: The IRPManager obtains the association result between the MDT measurement report and the RLF report and sent by the IRPAgent. Further, the IRPManager can perform location and analysis with respect to a cell coverage problem according to the association result.

It may be understood that the IRPManager and the IRPAgent in this embodiment are located in an OAM system.

Another embodiment similar to the foregoing embodiment provides a method for obtaining information, including step 1001 and step 1005 in the foregoing embodiment. Optionally, this embodiment may further include step 1002 and step 1004.

In this embodiment, through a configuration management operation in a management interface between an IRPManager and an IRPAgent in an OAM system, the IRPAgent timely feeds back information needed by the IRPManager, so that an operator timely obtains needed information to optimize cell coverage. In addition, the operator can flexibly subscribe, according to management application requirements, to needed information, for example, the associated RLF report and MDT measurement report, and add sources for collecting optimized information of coverage to increase accuracy in problem detection and location.

This embodiment may be combined with the foregoing embodiments that provide the method for associating reports. For example, in step 100 or step 200, the job type received by the source base station is sent by the IRPAgent in the OAM system to the source base station after the IRPAgent generates a signaling trace job according to the activate signaling trace job operation invoked by the IRPManager in the OAM system, where the activate signaling trace job operation is used to request the IRPAgent to generate a signaling trace job, where a job type of the signaling trace job is immediate MDT and RLF reporting. For another example, in step 1052 or step 2053, the IRPAgent in the OAM system receives an association result sent by the source base station, and may further send the association result to the TCE in the IRPManager for storing, so that the IRPManager performs location and analysis with respect to cell coverage problems.

Another embodiment of the present disclosure further provides an OAM system, including an IRPManager configured to execute the foregoing step 1001. Further, the IRPManager may be further configured to execute the foregoing step 1005. Optionally, the OAM system further includes an IRPAgent configured to execute the foregoing step 1002 to step 1004. The system can timely perform location and analysis with respect to cell coverage problems.

Through the descriptions of the foregoing implementation manners, a person skilled in the art may clearly understand that the present disclosure may be implemented using software plus necessary universal hardware, and certainly may be implemented using hardware. However, in most cases, the former is a preferred implementation manner. Based on such an understanding, the technical solutions of the present disclosure essentially, or the part contributing to the prior art may be implemented in the form of a software product. The computer software product is stored in a readable storage medium, for example, a floppy disk, a hard disk, or an optical disc of a computer, and includes several instructions for instructing a computer device (which may be a personal computer, a server, a network device, and the like) to execute the methods described in the embodiments of the present disclosure.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A method for associating reports, comprising:
sending, by a base station, to a user equipment (UE) that executes a minimized drive test (MDT) job an identifier allocated to the UE;
receiving, by the base station, a radio link failure (RLF) report of the UE, wherein the RLF report includes the identifier; and
associating, by the base station, the RLF report of the UE with an MDT measurement report that includes the identifier.

2. The method according to claim 1, wherein the sending, by a base station, an identifier to a UE that executes an MDT job comprises:
sending, by the base station, a radio resource control (RRC) connection reconfiguration message to the UE that executes the MDT job, wherein the message includes the identifier allocated to the UE.

3. The method according to claim 1, wherein the associating, by the base station, the RLF report of the UE with an MDT measurement report that includes the identifier comprises:
combining, by the base station, the RLF report of the UE with the MDT measurement report that includes the identifier.

4. The method according to claim 1, wherein after the associating, by the base station, the RLF report of the UE with an MDT measurement report that includes the identifier, the method further comprises:
reporting, by the base station, an association result between the RLF report of the UE and the MDT measurement report that includes the identifier to an operation, administration and maintenance (OAM) system.

5. The method according to claim 1, wherein:
the identifier is a combination of a trace reference (TR) and a trace recording session reference (TRSR) or a combination of a TR, a TRSR and a cell identifier.

6. The method according to claim 1, wherein if the base station is a base station shared by multiple public land mobile networks (PLMNs), the RLF report of the UE received by the base station further includes information of a registered PLMN of the UE or information of a home PLMN of the UE.

7. The method according to claim 1, further including receiving by the base station a job type sent by an operation, administration and maintenance (OAM) system, wherein when a value of the job type is immediate MDT and RLF reporting, the method further includes sending to the UE by the base station the identifier allocated to the UE.

8. The method according to claim 7, wherein the job type received by the base station is sent by an integration reference point agent (IRPAgent) in the OAM system to the base station after the IRPAgent generates a signaling trace job according to an activate signaling trace job operation invoked by an integration reference point manager (IRPManager) in the OAM system, wherein the activate signaling trace job operation is used to request the IRPAgent to generate a signaling trace job, wherein a job type of the signaling trace job is immediate MDT and RLF reporting.

9. A method for associating reports, comprising:
receiving, by a user equipment (UE) that executes a minimized drive test (MDT) job, an identifier allocated by a source base station of UE to the UE; and
when a radio link failure (RLF) occurs on the UE, sending, by the UE, an RLF report to a base station, wherein the RLF report includes the identifier allocated by the source base station to the UE, so that the RLF report of the UE is associated with an MDT measurement report that includes the identifier.

10. The method according to claim 9, wherein:
the identifier is a combination of a trace reference (TR) and a trace recording session reference (TRSR) or a combination of a TR, a TRSR and a cell identifier.

11. The method according to claim 9, wherein if the base station is a base station shared by multiple public land mobile networks (PLMNs), the RLF report sent by the UE to the base station includes information of a registered PLMN of the UE or information of a home PLMN of the UE.

12. The method according to claim 9, wherein the base station is the source base station of the UE or a target base station of the UE.

13. A base station, comprising:
a first sending unit, configured to send to a user equipment (UE) that executes a minimized drive test (MDT) job an identifier allocated to the UE;
a first receiving unit, configured to receive a radio link failure (RLF) report of the UE, wherein the RLF report includes the identifier; and
a first processing unit, configured to associate the RLF report of the UE with an MDT measurement report that includes the identifier.

14. The base station according to claim 13, wherein the first sending unit is configured to send a radio resource control (RRC) connection reconfiguration message to the UE that executes the MDT job, wherein the message includes the identifier allocated to the UE.

15. The base station according to claim 13, wherein the first processing unit is configured to combine the RLF report of the UE with the MDT measurement report that includes the identifier.

16. The base station according to claim 13, wherein the first sending unit is further configured to report an association result between the RLF report of the UE and the MDT measurement report that includes the identifier to an operation, administration and maintenance (OAM) system.

17. The base station according to claim 13, wherein the first receiving unit is further configured to receive a job type sent by an operation, administration and maintenance (OAM) system, and the first sending unit is further configured to: when a value of the job type received by the first receiving unit is immediate MDT and RLF reporting, send to the UE the identifier allocated to the UE.

18. The base station according to claim 17, wherein the job type received by the first receiving unit is sent by an integration reference point agent (IRPAgent) in the OAM system after the IRPAgent generates a signaling trace job according to an activate signaling trace job operation invoked by an integration reference point manager (IRPManager) in the OAM system, wherein the activate signaling trace job operation is used to request the IRPAgent to generate a signaling trace job, wherein a job type of the signaling trace job is immediate MDT and RLF reporting.

19. The base station according to claim 13, wherein the identifier is a combination of a trace reference (TR) and a trace recording session reference (TRSR) or a combination of a TR, a TRSR and a cell identifier.

20. The base station according to claim 13, wherein if the base station is a base station shared by multiple public land mobile networks (PLMNs), the RLF report of the UE received by the first receiving unit further includes information of a registered PLMN of the UE or information of a home PLMN of the UE.
